(19) United States
(12) Patent Application Publication
(10) Pub. No.: US 2026/0125310 A1
(43) Pub. Date: May 7, 2026

(54) RARE-EARTH DOPED FUNCTIONAL NANOCRYSTAL GLASS CERAMIC AND METHOD OF PREPARING THE SAME

(71) Applicants: WUHAN UNIVERSITY OF SCIENCE AND TECHNOLOGY, WUHAN (CN); SHANGHAI SIIC ZHENTAI CHEMICAL CO., LTD., SHANGHAI (CN)

(72) Inventors: GANG ZHANG, WUHAN (CN); WENYUE SUN, WUHAN (CN); SIHUA MENG, WUHAN (CN); ZHIPENG TANG, WUHAN (CN); KAIMING WU, WUHAN (CN); TAO FU, SHANGHAI (CN); JUN ZONG, SHANGHAI (CN)

(21) Appl. No.: 19/370,921

(22) Filed: Oct. 28, 2025

(30) Foreign Application Priority Data
Nov. 5, 2024 (CN) 202411569639.1

(51) Int. Cl. C03C 4/12; C03B 25/02; C03B 27/004; C03B 32/02; C03C 10/00; C09K 11/02; C09K 11/77

(52) U.S. Cl. CPC C03C 4/12; C03B 32/02; C03C 10/00; C09K 11/02; C09K 11/7769; C03B 25/02; C03B 27/004

(57) ABSTRACT

Disclosed is an Er³⁺ doped Lu₄Zr₃O₁₂ functional nanocrystal glass ceramic and a method of preparing the same. The glass ceramic comprises components in mole percentages of: 57% to 59% of SiO₂, 12% to 16% of Al₂O₃, 14% to 18% of ZnO, 6% to 8% of Li₂O, 3% to 5% of ZrO₂, 2% to 3% of Lu₂O₃, 0.05% to 0.2 of Er₂O₃. Through composition design and heat treatment process control, the present invention achieves the controllable preparation of Er³⁺ rare-earth ion-doped Lu₄Zr₃O₁₂ functional nanocrystals within the glass. This functional nanocrystalline glass has potential application value in low-temperature optical thermometry.

### FIELD

The disclosure relates to the field of glass, and in particular to an Er³⁺ doped Lu₄Zr₃O₁₂ functional nanocrystal glass ceramic and a method of preparing the same.

### BACKGROUND OF THE INVENTION

Oxides composed of RE₂O₃-MO₂ (RE=La—Lu; M=Ti, Zr, Hf) are interesting materials and possess many interesting properties. These oxides could have defect-fluorite structure, pyrochlore structure, or delta (δ)-phase rhombohedral structure, depending on the chemical compositions of these oxides and exhibit order-disorder transitions, such as pyrochlore to defect fluorite, rhombohedral 8-phase to defect fluorite, and β-phase (hexagonal) to defect fluorite, which are strongly dependent on the temperature and the annealing time. Chemical formula of oxides in these systems can be generally expressed as [AB]₂O₈₋ₓ such as A₂B₂O₇ pyrochlores, A₄B₃O₁₂ δ-phase, and A₂BO₅ β-phase, where A and B are trivalent and tetravalent cations, respectively. In most cases, these oxides have good physical and chemical properties, especially the low thermal conductivity and high solubility of rare-earth ions. These particular properties make these oxides promising for applications as thermal barrier coatings, nuclear waste form, host for luminescent rare-earth ions, and pigments.

In recent years, δ-phase RE₄Zr₃O₁₂ crystals are intensely studied for their optical properties, such as UV-emission from Y₄Zr₃O₁₂:Gd³⁺, red-emission from Y₄Zr₃O₁₂:Eu³⁺ for latent fingerprint. Most of these materials are synthesized through the sol-gel technique followed by high temperature sintering, sintering, co-precipitation or mechanical activation, and solution combustion method. However, δ-phase RE₄Zr₃O₁₂ crystals were not directly synthesized in glasses. Therefore, there is a need to provide a new material and method capable of precipitating δ-phase RE₄Zr₃O₁₂ in glass.

### BRIEF DESCRIPTION OF DRAWINGS

To describe technical solutions in embodiments of the disclosure more clearly, accompanying drawings required in description of the embodiments will be briefly introduced below. Apparently, the accompanying drawings in the following description merely show some embodiments of the disclosure, and a person of ordinary skill in the art can still derive other accompanying drawings from structures shown in these accompanying drawings without creative efforts.

FIG. 1 is XRD patterns of Lu₄Zr₃O₁₂ functional nanocrystal glass ceramic obtained by heat-treating as-prepared (hereinafter referred to as AP) glass of First Embodiment at different temperatures.

FIG. 2 shows transmission electron microscopy (TEM) images of the functional nanocrystal glass ceramic obtained at 760° C. in FIG. 1, where Chart a illustrates a bright-field image, Chart b illustrates a magnified image, and Chart c illustrates an HR-TEM image.

FIG. 3 shows EDS mapping results of the functional nanocrystal glass ceramic obtained at 760° C. in FIG. 1, where Chart a illustrates dual-field image of the specimen, Chart b illustrates distribution of Lu, Chart c illustrates distribution of Zr, Chart d illustrates distribution of Er, Chart e illustrates distribution of Si, Chart f illustrates distribution of Zn, Chart g illustrates distribution of Al, and Chart h illustrates distribution of O.

FIG. 4 shows temperature dependent emission properties of the functional nanocrystal glass ceramic heat-treated at 760° C. for 6 h, where Chart a illustrates normalized emission spectra of the functional nanocrystal glass ceramic, Chart b illustrates emission intensity ratio between the ²H_{11/2}→⁴I_{15/2} and ⁴S_{3/2}→⁴I_{15/2} transitions, and Chart c illustrates relative sensitivity (SR) and absolute sensitivity (SA) curves.

### DETAILED DESCRIPTION OF THE INVENTION

The following will provide a further explanation of the present disclosure in conjunction with the accompanying drawings. The patent or application file contains at least one drawing executed in color, which is for illustrative purpose only and forms no part thereof.

### First Embodiment

An Er³⁺ doped Lu₄Zr₃O₁₂ functional nanocrystal glass ceramic is provided in the first embodiment. The glass ceramic includes a glass matrix and nanocrystals composed of Lu₄Zr₃O₁₂ and Er³⁺ within the glass matrix. The glass ceramic composition, in mole percent, includes 58 mol % of SiO₂, 13 mol % of Al₂O₃, 15 mol % of ZnO, 7 mol % of Li₂O, 4 mol % of ZrO₂, 2.9 mol % of Lu₂O₃, 0.1 mol % of Er₂O₃, and additionally includes 0.2 mol % of Sb₂O₃ as an extra component.

The raw materials are weighed according to the above composition and mixed uniformly, then melted at 1630° C. for 2 h in platinum crucible and then poured into brass mold for quenching. The quenched glass is swiftly transferred into a muffle furnace for annealing at 630° C. for 3 h and cooling down to room temperature with furnace by switching off the power. Glass thus obtained is named as as-prepared (hereinafter referred to as AP) glass. The AP glass is then heat-treated at 700° C., 720° C., 740° C., and 760° C. for 6 hours to obtain the Lu₄Zr₃O₁₂ functional nanocrystal glass ceramic.

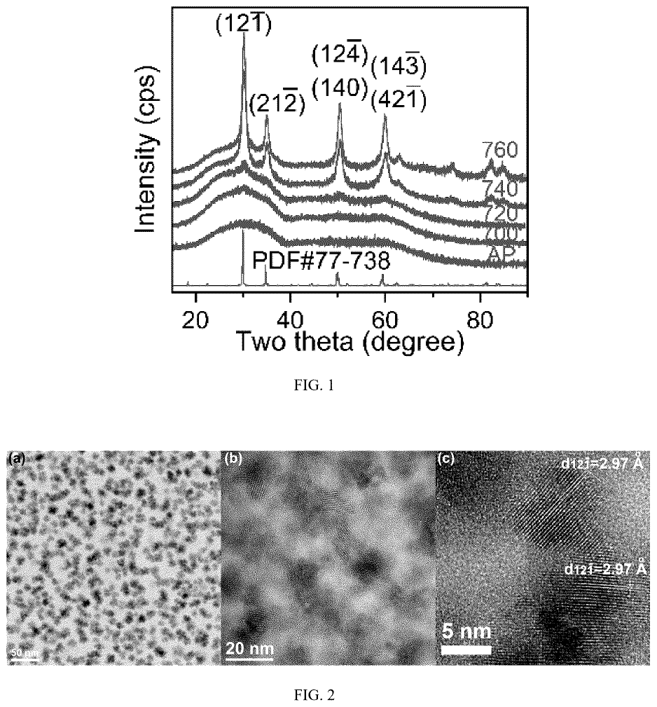

As shown in FIG. 1, for the AP specimen, only broad diffraction halo is observed (FIG. 1), indicating that the AP specimen is mainly amorphous and no detectable nanocrystalline phases are present. Upon heat-treatment at 700° C., one weak diffraction peak appears at 30°, and, with the increase in heat-treatment temperature, this peak is gradually intensified along with the appearance of other diffraction peaks at larger diffraction angles (FIG. 1). These diffraction peaks are found to be consistent with those of Lu₄Zr₃O₁₂ crystal (PDF #77-738, space group R3̅), indicating the precipitation of Lu₄Zr₃O₁₂ nanocrystals in the heat-treated glasses.

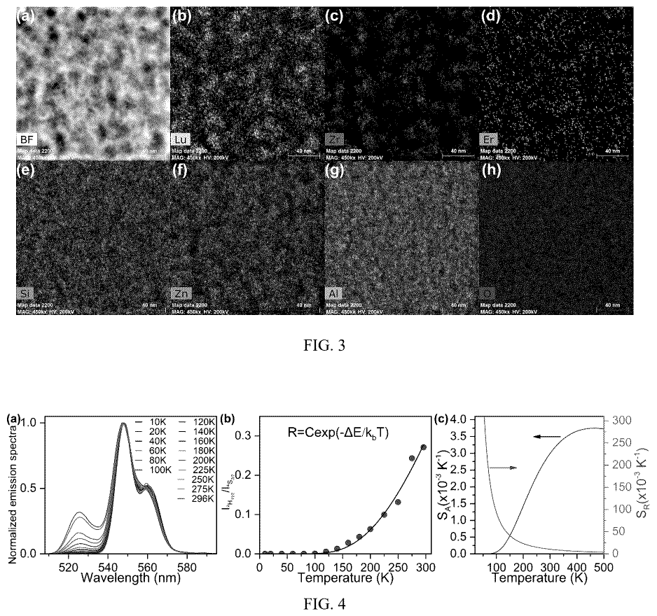

As can be seen from FIG. 2, precipitation of these nanocrystals in heat-treated glasses is further analyzed using specimen heat-treated at 760° C. for 6 h as typical example. After heat treatment, many dark spots (10-25 nm) are observed in the specimen, and these dark spots are nearly homogeneously distributed within the specimen (Chart a of FIG. 2). In the magnified image shown in Chart b of FIG. 2, these dark spots are found to be composed of several small nanocrystals (5-10 nm) with clear lattice fringes, indicating agglomeration of the small nanocrystals. The HR-TEM image (Chart c of FIG. 2) shows that interplanar distances of these small nanocrystals are ˜2.97 μm, compatible with the interplanar distance of Lu₄Zr₃O₁₂ crystal (=2.9763 μm, PDF #77-738). Both the XRD patterns and HR-TEM images confirm that Lu₄Zr₃O₁₂ nanocrystals are precipitated in the glasses upon heat-treatment. To further confirm the precipitation of Lu₄Zr₃O₁₂ nanocrystals in glasses after heat-treatment, EDS mapping of the specimen treated at 760° C. for 6 h is carried out, as shown in FIG. 3. Elemental mapping in the region shown in Chart a of FIG. 3 indicates that Lu (Chart b of FIG. 3) and Zr (Chart c of FIG. 3) are concentrated in these nanocrystals, consistent with XRD and TEM analysis results. Although the concentration of Er₂O₃ in the glass is low and the contrast in Chart d of FIG. 3 is relatively weak, the distribution of Er (Chart d of FIG. 3) is still largely consistent with the distribution of Lu and Zr, indicating that Er³⁺ ions are probably incorporated into Lu₄Zr₃O₁₂ nanocrystals. Other elements, such as Si (Chart e of FIG. 3), Zn (Chart f of FIG. 3), Al (Chart g of FIG. 3) and O (Chart h of FIG. 3), are nearly homogeneously distributed in the specimen.

Incorporation of Er³⁺ ions into Lu₄Zr₃O₁₂ nanocrystals during heat-treatment changes the local environment and optical properties of Er³⁺ ions. In order to evaluate the potential of these glass-ceramics doped by Er³⁺:Lu₄Zr₃O₁₂ nanocrystals for low-temperature optical thermometry, temperature dependent emission spectra of specimen heat-treated at 760° C. for 6 h are recorded (as shown in FIG. 4). Chart a of FIG. 4 shows the normalized emission spectra recorded at 10-296 K. The absolute temperature sensitivity S_{A} increases with temperature and reaches the maximum at 465 K, and the relative temperature sensitivity SR decreases with temperature (Chart c of FIG. 4). At 300 K, the S_{A} is 0.3% K⁻¹, the SR is 1.03% K⁻¹. The results show that the glass-ceramics containing Er³⁺:Lu₄Zr₃O₁₂ nanocrystals can be potentially useful for optical thermometry in the low temperature range.

### Second Embodiment

This embodiment is substantially the same as the first Embodiment, with the difference that the glass ceramic composition in this embodiment, in mole percent, includes 57 mol % of SiO₂, 16 mol % of Al₂O₃, 18 mol % of ZnO, 6 mol % of Li₂O, 3 mol % of ZrO₂, 2 mol % of Lu₂O₃, 0.2 mol % of Er₂O₃, and additionally includes 0.1 mol % of Sb₂O₃ as an extra component. The AP glass is heat-treated at 760° C. for 6 hours. At 300K, the S_{A} is 0.25% K⁻¹ and the SR is 1.13% K⁻¹.

### Third Embodiment

This embodiment is substantially the same as the first Embodiment, with the difference that the glass ceramic composition in this embodiment, in mole percent, includes 59 mol % of SiO₂, 12 mol % of Al₂O₃, 14 mol % of ZnO, 8 mol % of Li₂O, 5 mol % of ZrO₂, 3 mol % of Lu₂O₃, 0.05 mol % of Er₂O₃, and additionally includes 0.3 mol % of Sb₂O₃ as an extra component. The AP glass is heat-treated at 760° C. for 6 hours. At 300K, the S_{A} is 0.28% K⁻¹ and the SR is 1.20% K⁻¹.

Although the disclosure has been described with reference to preferred embodiments, various modifications may be made thereto and equivalents may be substituted for parts thereof without departing from the scope of the invention. In particular, the technical features mentioned in the various embodiments can be combined in any way as long as there are no structural conflicts. the disclosure is not limited to the specific embodiments disclosed herein but encompasses all technical solutions falling within the scope of the claims.

1. A rare-earth ion doped functional nanocrystal glass ceramic, comprising a glass matrix and Lu₄Zr₃O₁₂ nanocrystals doped with Er³⁺ dispersed within the glass matrix, the glass ceramic comprises components in mole percentages of: 57% to 59% of SiO₂, 12% to 16% of Al₂O₃, 14% to 18% of ZnO, 6% to 8% of Li₂O, 3% to 5% of ZrO₂, 2% to 3% of Lu₂O₃, 0.05% to 0.2 of Er₂O₃, a total mole percent of the components is 100%.

2. The rare-earth ion doped functional nanocrystal glass ceramic according to claim 1, wherein size of the nanocrystal is 5-10 nm.

3. The rare-earth ion doped functional nanocrystal glass ceramic according to claim 1, wherein the glass ceramic further comprises 0.1 mol % to 0.3 mol % of Sb₂O₃.

4. A method for preparing the rare-earth ion doped functional nanocrystal glass ceramic according to claim 1, comprising steps of:
weighing and uniformly mixing all raw materials to obtain a raw material mixture;
placing the raw material mixture in a crucible, and melting at 1600° C. to 1650° C. from 1 h to 3 h to obtain a molten glass;
pouring the molten glass into a mold for quenching to obtain a quenched glass;
annealing the quenched glass at 600-650° C. for 2-4 hours and cooling to room temperature to obtain an as-prepared glass;
heat-treating the as-prepared glass at 700-800° C. for 5-7 hours to obtain the Lu₄Zr₃O₁₂ functional nanocrystal glass ceramic.
